(19) United States
(12) Patent Application Publication
(10) Pub. No.: US 2007/0087447 A1
(43) Pub. Date: Apr. 19, 2007

(54) System and method of free radical initiated protein sequencing

(76) Inventors: Jesse L. Beauchamp, La Canada Flintridge, CA (US); Robert Hodyss, Pasadena, CA (US); Heather Sumner, South Pasadena, CA (US)

Correspondence Address: CHRISTIE, PARKER & HALE, LLP, PO BOX 7068, PASADENA, CA, 91109-7068, US

(21) Appl. No.: 11/474,028

(22) Filed: Jun. 23, 2006

Related U.S. Application Data
(60) Provisional application No. 60/694,143, filed on Jun. 24, 2005.

(51) Int. Cl. G01N 24/00

(52) U.S. Cl. 436/173; 436/177

(57) ABSTRACT

A method for the selective fragmentation of peptides using free radical initiator-peptide conjugates is provided. Free radical initiated peptide sequencing, or FRIPS, consists of covalently attaching a free radical initiator to a peptide and collisionally activating this conjugate. This results in fragment formation. Subsequent collision-activated dissociation further dissociates the fragments, producing a group of ions based on the interaction of the free radical initiator and the target molecule. The methodology is applied to the fundamental study of biologically relevant reactions of free radicals with peptides and proteins in the gas phase, as well as to a completely gas-phase approach to protein sequencing.

### CROSS-REFERENCE TO RELATED APPLICATIONS

This application claims priority based on U.S. provisional application No. 60/694,143, filed Jun. 24, 2005, the disclosure of which is incorporated herein by reference.

### STATEMENT OF FEDERAL FUNDING

The Government has certain rights in this invention, based on support for the work under a grant from the National Science Foundation (Grant No. R01 HG002644).

### FIELD OF THE INVENTION

The current invention is directed generally to a method of protein sequencing; and more particularly to a protein sequencing technique using free radical reactions.

### BACKGROUND OF THE INVENTION

The human genome has been sequenced, and identifying the composition of the proteome is one of the next major challenges ahead. New generations of diagnostic tools, designed to obtain a complete understanding of what proteins normally exist in cells and how the composition of these proteins changes when a disease state is present, would benefit greatly from a fast and efficient technology to rapidly identify such proteins.

Mass spectrometry (MS) is the current state-of-the-art in peptide and protein sequencing techniques. MS allows for the analysis of small proteins when coupled with the enzymatic proteolysis of proteins. In this technique the proteolytic peptides are typically sequenced via collisionally induced dissociation (CID, also referred to as collisionally assisted dissociation or CAD) or electron capture dissociation (ECD) of the cationized species. (See, e.g., Laskin, J.; Futrell, J. H. Mass Spectrom. Rev. 2003, 22, 158; Zubarev, R. A. Mass Spectrom. Rev. 2003, 22, 57; Zubarev, R. A.; Horn, D. M.; Fridriksson, E. K.; Kelleher, N. L.; Kruger, N. A.; Lewis, M. A.; Carpenter, B. K.; McLafferty, F. W. Anal. Chem. 2000, 72, 563; and Standing, K. G. Curr. Opin. Struct. Biol. 2003, 13, 595, the disclosure of which are incorporated herein by reference.) One limitation encountered with this technique is that it requires the use of enzymatic digests to cleave the backbone of the proteins at specific amino acid sites resulting in significantly reduced throughputs for proteomic analyses. Accordingly, the search for alternative techniques has been the focus of a substantial amount of recent research.

For example, previous work has examined several types of enhanced reactivity of proteins in the gas phase. Enhanced cleavage of the peptide backbone C-terminal to an acidic residue has been observed in both protonated and sodiated peptides. (See, e.g., Gu, C.; Tsaprailis, G.; Breci, L.; Wysocki, V. H. Anal. Chem. 2000, 72, 5804; and Lee, S.-W.; Kim, H. S.; Beauchamp, J. L. J. Am. Chem. Soc. 1998, 120, 3188, the disclosures of which are incorporated herein by reference.) Cleavages of peptide bonds are often enhanced when they are N-terminal to proline residues (Loo, J. A.; Edmonds, C. G.; Smith, R. D. Anal. Chem. 1993, 65, 425, the disclosure of which is incorporated herein by reference), and C-terminal to histidine residues (Tsaprailis, G.; Nair, H.; Zhong, W.; Kuppannan, K.; Futrell, J. H.; Wysocki, V. H. Anal. Chem. 2004, 76, 2083, the disclosure of which is incorporated herein by reference). Transition metals can also be used to facilitate cleavage at a specific amino acid; for example, Zn²⁺, Cu²⁺, Ni²⁺, and Co²⁺ enhance cleavage at histidine residues, while Fe²⁺ enhances cleavage at cysteine residues. (See, e.g., Hu, P.; Loo, J. A. J. Am. Chem. Soc. 1995, 117, 11314; and Nemirovskiy, O. V.; Gross, M. L. J. Am. Soc. Mass Spectrom. 1998, 9, 1285, the disclosures of which are incorporated herein by reference.)

Other researchers have investigated the fragmentation patterns arising from radical peptides. Specifically, proteins containing free radicals are important players in many enzyme catalysis reactions. (Stubbe, J.; van der Donk, W. A., Protein radicals in enzyme catalysis. Chem. Rev. 1998, 98, 705-762, the disclosure of which is incorporated herein by reference.) In other environments, free radicals in peptides and proteins contribute to disease states, as well as the aging process. (Stadtman, E. R., Oxidation of free amino acids and amino acid residues in proteins by radiolysis and by metal-catalyzed reactions. Annual Review of Biochemistry 1993, 62, 797-821; Hensley, K.; Carney, J. M.; Mattson, M. P.; Aksenova, M.; Harris, M.; Wu, J. F.; Floyd, R. A.; Butterfield, D. A., A model for beta-amyloid aggregation and neurotoxicity based on free radical generation by the peptide: relevance to Alzheimer disease. Proceedings of the National Academy of Sciences of the United States of America 1994, 91, 3270-3274; and Murakami, K.; Irie, K.; Ohigashi, H.; Hara, H.; Nagao, M.; Shimizu, T.; Shirasawa, T., Formation and stabilization model of the 42-mer A-beta radical: implications for the long-lasting oxidative stress in Alzheimer's disease. Journal of the American Chemical Society 2005, 127, 15168-15174, the disclosures of which are incorporated herein by reference.) As a result, there has been significant interest in the behavior of amino acids, peptides, and proteins that are attacked by radicals and the subsequent products of such reactions.

Radical reactions can also elicit structural information about peptides and proteins, both in the gas phase and in solution. The (solution phase) radiolysis of such species has been extensively studied and the reactions of hydroxyl radicals with side chains on proteins can be used to examine solvent-accessible sites in a protein. (See, e.g., Garrison, W. M., Reaction mechanisms in the radiolysis of peptides, polypeptides, and proteins. Chem. Rev. 1987, 87, 381-398; Guan, J.-Q.; Almo, S. C.; Chance, M. R., Synchrotron radiolysis and mass spectrometry: a new approach to research on the actin cytoskeleton. Accounts of Chemical Research 2004, 37, 221-229; and Maleknia, S. D.; Brenowitz, M.; Chance, M. R., Millisecond radiolytic modification of peptides by synchrotron X-rays identified by mass spectrometry. Analytical Chemistry 1999, 71, 3965-3973, the disclosures of which are incorporated herein by reference.) In these hydroxyl footprinting reactions, hydroxyl radicals preferentially react with side chains of amino acid residues.

In one gas-phase method, peptide radical cations can be generated by dissociation of complexes such as [Cu(II)(L₃)M]²⁺, where L₃ is a tridentate ligand. (Wee, S.; O'Hair, R. A. J.; McFadyen, W. D., Comparing the gas-phase fragmentation reactions of protonated and radical cations of the tripeptides GXR. Int. J. Mass Spectrom. 2004, 234, 101-122; Bagheri-Majdi, E.; Ke, Y.; Orlova, G.; Chu, I. K.; Hopkinson, A. C.; Siu, K. W. M., Copper-mediated peptide radical ions in the gas phase. J. Phys. Chem. B 2004, 108, 11170-11181; Barlow, C. K.; Wee, S.; McFadyen, W. D.; O'Hair, R. A. J., Designing copper(II) ternary complexes to generate radical cations of peptides in the gas phase: role of the auxiliary ligand. Dalton Trans. 2004, 3199-3204; Gatlin, C. L.; Turecek, F.; Vaisar, T., Copper(II) amino acid complexes in the gas phase. Journal of the American Chemical Society 1995, 117, 3637-3638; Chu, I. K.; Rodriquez, C. F.; Lau, T.-C.; Hopkinson, A. C.; Siu, K. W. M., Molecular radical cations of oligopeptides. J. Phys. Chem. B 2000, 104, 3393-3397; and Barlow, C. K.; McFadyen, W. D.; O'Hair, R. A. J., Formation of cationic peptide radicals by gas-phase redox reactions with trivalent chromium, manganese, iron, and cobalt complexes. Journal of the American Chemical Society 2005, 127, 6109-6115, the disclosures of which are incorporated herein by reference.) The technique of electron capture dissociation (ECD), pioneered by Zubarev et al., consists of creating radical peptide or protein cations by irradiating a multiply charged biomolecule with low-energy electrons. (Zubarev, R. A.; Kelleher, N. L.; McLafferty, F. W., Electron capture dissociation of multiply charged protein cations. A nonergodic process. Journal of the American Chemical Society 1998, 120, 3265-3266, the disclosure of which is incorporated herein by reference.) The subsequent radical cation is then subjected to collisonally activated dissociation (CAD) to produce c and z type fragments. Many more backbone sites are cleaved in ECD than in collisional activation of non-radical peptides, resulting in more complete coverage of a peptide sequence. (Zubarev, R. A.; Horn, D. M.; Fridriksson, E. K.; Kelleher, N. L.; Kruger, N. A.; Lewis, M. A.; Carpenter, B. K.; McLafferty, F. W., Electron capture dissociation for structural characterization of multiply charged protein cations. Analytical Chemistry 2000, 72, 563-573, the disclosure of which is incorporated herein by reference.) One advantage of this method is that post-translational modifications such as phosphorylation and glycosolation are retained in the ECD process. (Mirgorodskaya, E.; Roepstorff, P.; Zubarev, R. A., Localization of o-glycosylation sites in peptides by electron capture dissociation in a Fourier transform mass spectrometer. Analytical Chemistry 1999, 71, 4431-4436; Stensballe, A.; Jensen, O. N.; Olsen, J. V.; Haselmann, K. F.; Zubarev, R. A., Electron capture dissociation of singly and multiply phosphorylated peptides. Rapid Communications in Mass Spectrometry 2000, 14, 1793-1800; and Heeren, R. M. A.; Kleinnijenhuis, A. J.; McDonnell, L. A.; Mize, T. H., A mini-review of mass spectrometry using high-performance FTICR-MS methods. Anal. Bioanal. Chem. 2004, 378, 1048-1058, the disclosures of which are incorporated herein by reference.) However, the selectivity of this technique is significantly limited, and it requires the use of at least doubly charged cationic peptides.

Several researchers have also independently investigated radical peptides and their dissociation patterns in an attempt to achieve more selective fragmentation. For example, some investigations have used the high affinity of 18-crown-6 for lysine residues to attach a diazo 18-crown-6 reagent to a peptide at the lysine residues and collisionally activate the resulting non-covalently bound complex in order to form a highly reactive carbene. In this technique the carbene reacts to form covalent bonds with the peptide, but the resulting molecule fragments readily and does not yield sequence-specific information. (See, e.g., Julian, R. R.; May, J. A.; Stoltz, B. M.; Beauchamp, J. L. Angew. Chem. Int. Ed. 2003, 42, 1012, the disclosure of which is incorporated herein by reference.) Porter et al. have modified lysine residues in solution to convert them to peroxycarbamates and find that CID of species complexed with Li⁺, Na⁺, K⁺, and Ag⁺ result in loss of —C(O)OOtBu to give a radical amine at the lysine side chain. (See, e.g., Porter, et al., cited above.) However, CAD of the radical peptide results mainly in fragmentation of the lysine side chain, and only rarely is the peptide backbone also cleaved.

Accordingly, a need still exists for a method that would provide the ability to selectively cleave the protein backbone at specific amino acid residues in the gas phase that would in turn provide a viable alternative to enzymatic digests and result in significantly higher throughputs for proteomic analyses.

### SUMMARY OF THE INVENTION

The current invention is directed to a method of selectively fragmenting peptides and proteins using free radical reactions, referred to herein as free radical initiated peptide sequencing (FRIPS).

In one embodiment, the FRIPS method consists of covalently attaching a free radical initiator to a peptide and collisionally activating this conjugate. In such an embodiment, the methodology can be applied to the fundamental study of biologically relevant reactions of free radicals with peptides and proteins in the gas phase. It also has potential as a key analytical component to a completely gas-phase approach to protein sequencing.

In one embodiment, the FRIPS technique can be used to obtain a, c, x or z-type fragments when collisionally activated.

In another embodiment the FRIPS technique of the current invention can be used to determine the secondary structure of the peptide.

In still another embodiment, the FRIPS technique of the current invention can provide information complementary to that obtained with existing gas-phase sequencing techniques.

In yet another embodiment, reagents that selectively cleave peptides may be designed using the FRIPS technique of the current invention.

In still yet another embodiment, the FRIPS technique of the current invention may be used with anions and cations (singly and multiply charged).

In still yet another embodiment the FRIPS technique of the current invention allows for the selective/non selective fragmentation.

In still yet another embodiment the FRIPS technique of the current invention may be used to preserve and investigate post-translational modifications (PTMs).

In still yet another embodiment the FRIPS technique of the current invention may be used to investigate isomers, such as leucine and isoleucine.

In still yet another embodiment the FRIPS technique of the current invention the radicals can be generated photochemically.

In still yet another embodiment the FRIPS technique of the current invention may be used to observe bimolecular reactions of free radicals with peptides.

In still yet another embodiment the FRIPS technique of the current invention may be used with biomimetic reagents by combining free radical sources with selective non-covalent binding reagents such as 18-crown-6 ether.

In still yet another embodiment the FRIPS technique of the current invention may employ other ionization methods (e.g. LDI or MALDI).

### BRIEF DESCRIPTION OF THE DRAWINGS

These and other features and advantages of the present invention will be better understood by reference to the following detailed description when considered in conjunction with the accompanying drawing wherein:

FIG. 1 shows a schematic of an embodiment of the FRIPS process in accordance with the current invention.

FIG. 2 shows data graphs from (a) the collisionally activated dissociation (CAD) of AARAAASAA; (b) collisionally activated dissociation of rAARAAASAA; and (c) the collisionally activated dissociation of AARAAAAAA.

FIG. 3 shows data graphs for fragments observed from the CAD of radical peptides.

FIG. 4 shows data graphs from (a) CAD of rAARAAAYAA; and (b) CAD of rAAYAAARAA.

FIG. 5 shows data graphs from (a) the collisional activation of rAARAAALAA; and (b) the collisional activation of rAARAAAIAA.

FIG. 6 shows (a) a full scan showing doubly angiotensin II (Ang II) and Vazo 68 derivatized angiotensin II; and (b) spectrum resulting from CID of the derivatized peptide shown in Schematic 3, where the arrows point to the dissociated species.

FIG. 7 shows (a) spectrum resulting from collision-induced dissociation of the doubly protonated free radical species formed in FIG. 6; and (b) spectrum resulting from collision-induced dissociation of doubly protonated angiotensin II, where the arrows point to the dissociated species.

FIG. 8 shows (a) spectrum resulting from CID of the doubly protonated molecule shown in Schematic 4, where the peptide is bradykinin; and (b) spectrum resulting from CID of doubly protonated unmodified bradykinin, where the arrows point to the dissociated species.

FIG. 9 shows (a) spectrum resulting from CID of the doubly protonated molecule shown in Schematic 4 for anxiety peptide, QATVGDVNTDRPGLLDLK; and (b) spectrum resulting from CID of doubly protonated anxiety peptide, where the arrows point to the dissociated species.

FIG. 10 shows (a) spectrum resulting from collision-induced dissociation of the singly negatively charged molecule shown in Schematic 4 for met-enkephalin; and (b) spectrum resulting from CID of singly negatively charged met-enkephalin.

FIG. 11 shows (a) mass spectrum of a solution containing 12 μM prodynorphin (PDN) and 12 μM 5.1; (b) dissociation of the +3 adduct that shows loss of N₂ and loss of the molecule shown in Schematic 1; (c) dissociation of the +4 adduct that shows an activation product, [5.5+PDN+4H]⁴⁺; and (d) dissociation of the activation product that yields mostly PDN, but small fragmentation products are also observed.

FIG. 12 shows a CAD spectrum of singly protonated phosphorylated Angiotensin II, DRV[pY]IHPF.

FIG. 13 shows a FRIPS spectrum of species 2 in Scheme 14.

FIG. 14 shows a FRIPS spectrum of species 3 in Scheme 14.

FIG. 15 shows a FRIPS spectrum of a ubiquitin-Vazo 68 conjugate.

### DETAILED DESCRIPTION OF THE INVENTION

General Mechanism of Frips

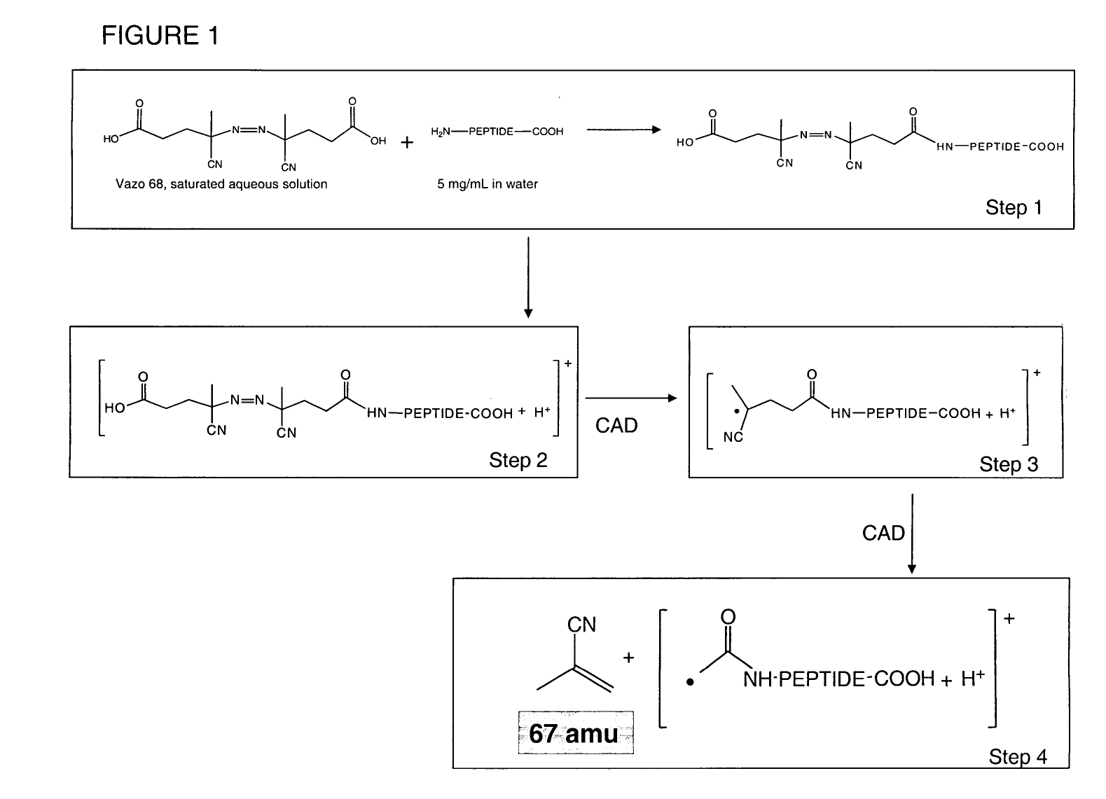

The current invention is directed to a method of peptide and protein sequencing using free radical reactions. Free radical initiated peptide sequencing (FRIPS) is a novel method of sequencing peptides in the gas phase. As shown in the flow chart in FIG. 1, in its broadest form FRIPS uses standard peptide coupling techniques to conjugate a free radical initiator to the N-terminus of a peptide or protein (Step 1). This conjugated species is then electrosprayed into a mass spectrometer (Step 2) and collisionally activated (Step 3) to produce a fragment species. Subsequent collisional dissociation further break apart these fragment species (Step 4), producing ions, which can then be analyzed by standard techniques, such as mass spectrometry. (It should be noted that generation of the fragments can be observed both in positive and negative ion modes using this technique.)

Although the following sections will focus on the use of the FRIPS process to form radicals including peptide radicals, FRIPS may also be used to produce fragments that are not radicals. In addition, although the following discussion will focus on the further dissociation of these fragments into z-type ions it should be understood that FRIPS can produce other ion types, including, for example, a, b, c, x, and y-type ions, as well as ions resulting from amino acid side chain fragmentation. The types of fragment species produced, and in turn the types of fragment ions produced are dependent on the nature of the free radical initiator and its interaction with the peptide or protein, allowing for a controllable process. Further, unlike previous gas phase techniques like ECD, singly charged peptides can be observed using FRIPS.

Although specific exemplary embodiments using particular free radical initiators will be discussed in this application, it should be understood that any free radical initiator capable of being bonded to a peptide or protein may be utilized by the current method, such as, for example, nitrites, alkoxyamines, disulfides, and peroxide based initiators among others. Indeed, as discussed above, one of the novel advantages of the FRIPS process is the ability to control the selectivity of the sequencing process. Specifically, in FRIPS different free radical initiators could produce 1°, 2°, or 3° radicals with different reactivities. Highly reactive radicals will indiscriminately abstract hydrogen atoms from different sites on the peptide, leading to non-selective fragmentation. More stable radicals, on the other hand, will abstract only the hydrogens that are weakly bound to the peptide, leading to more selective fragmentation. As such, using FRIPS the degree of selectivity can be controlled by the reactivity of the radical conjugated peptide. Accordingly, the selection of the free radical initiator will depend on the nature of the peptide or protein and the selectivity of the fragmentation process desired. The following discussion will provide the framework for selecting a free radical initiator species for use in the FRIPS process.

As will be understood by one of ordinary skill in the are, the reactivity of the radical can be changed by altering the structure of the azo species conjugated to the peptide. For example, the radical produced in the decomposition of Vazo 68 (Scheme 1, below) is relatively stable, and hence selectively reactive. 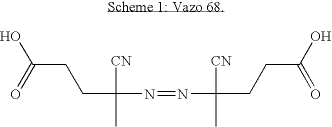
Isobutyronitrile, a model for the radical derived from Vazo 68, has a C—H bond energy at the 3° carbon of 362±8 kJ/mol. (See, e.g., McMillen, D. F.; Golden, D. M. Annu. Rev. Phys. Chem. 1982, 33, 493, the disclosure of which is incorporated herein by reference.) This is much less than the 1°, 2°, and 3° C—H bond energies of ethane (423±2 kJ/mol), propane (413±2 kJ/mol), and isobutane (404±2 kJ/mol), indicating the stability of the Vazo 68 radical over these hydrocarbon radicals. (See, e.g., Blanksby, S. J.; Ellison, G. B. Acc. Chem. Res. 2003, 36, 255, the disclosure of which is incorporated herein by reference.) Accordingly, the synthesis of different azo compounds offers the possibility of tuning the reactivity of the conjugated peptide to enhance or diminish reactivity of the FRIPS process. For example, the 3° C—H bond in 1,1-diphenylethane has a bond dissociation energy (BDE) of 338.9±8 kJ/mol and would be a more selective radical initiator than Vazo 68. In addition, choosing a free radical initiator with less probability of internal fragmentation (such as the loss of 2-methyl acrylonitrile observed for Vazo 68) would result in more peptide backbone fragments. Accordingly, it should be understood that although exemplary radicals with exemplary bond energies have been discussed thus far, the bond energies of any free radical initiator molecules can be determined through well-know thermodynamic calculations.

The BDEs of these free radical initiator molecules can then be compared to the BDEs for the amino acids that make up a peptide or protein to determine the nature and extent of fragmentation that will occur during the FRIPS process. Exemplary BDEs for model amino acid side chains are provided in Table 1, below.

TABLE 1
Model bond dissociation energies for amino acid side chains.

| Amino Acid | Model Compound | BDE (kJ/mol)²⁶ |
|---|---|---|
| Serine | H—CH(CH₃)OH | 389 |
| Threonine | H—C(OH)(CH₃)₂ | 380 |
| Phenylalanine | H—C(CH₂)(C₆H₅) | 357 |
| Tyrosine | H—OC₆H₅ | 362 |
| | H—C(CH₂)(C₆H₅) | 357 |
| Leucine | H-t-C₄H₉ | 390 |
| Isoleucine | H-t-C₄H₉ | 390 |
| Alanine | H—C₂H₅ | 423 |

Although not to be bound by theory, the mechanisms put forth throughout this paper indicate abstraction of side chain hydrogen, rather than the α hydrogen found on the backbone of the peptide during FRIPS. Energetically, this is quite feasible. Acetone, a model for the radical site considered in this paper, has a C—H BDE of 411 kJ/mol. (See, e.g., Nauser, T.; Schöneich, C. J. Am. Chem. Soc. 2003, 125, 2042, the disclosure of which is incorporated herein by reference.) As shown in Table 1, above the BDE values of the model amino acid side chains are all below 411 kJ/mol, indicating that these hydrogens should be able to be abstracted by the radical site. Secondary structure also seems impact the BDE of the amino acid side chain hydrogens found in the peptide. For example, calculations on amino acid residues indicate that the α hydrogen is the most easily abstracted hydrogen in amino acids, with bond dissociation energies (BDEs) ranging from 326-369 kJ/mol depending on the side chain. This is attributed to the captodative effect, which here implies delocalization of the radical with the carbonyl of the amide group and the N atom of the amide link. Because of this dependence on the geometry of the peptide, secondary structure can increase the BDE of these hydrogens by as much as 40 kJ/mol. Accordingly, as will be discussed further, information on the secondary structure of the peptide through the FRIPS method

Although the above discussion has focused on the use of the thermodynamic properties of the radicals to determine the selectivity of the FRIPS process, other types of reaction parameters may be used either alone or in conjunction with these thermodynamic factors to help in determining the selectivity of the inventive FRIPS reagents. For example, the reaction trends of thiyl radicals with peptides can sometimes correlate poorly with BDEs of α-C—H bonds. (See, Nauser, cited above.) Take for example the activation energy of thermolysis of AIBN, a model compound for Vazo 68, is 128 kJ/mol in benzene, an apolar solvent that should provide a reasonable approximation to gas phase conditions. (Engel, P. S. Chem. Rev. 1980, 80, 99, the disclosures of which are incorporated herein by reference.) Blackbody infrared radiative dissociation (BIRD) experiments have measured the activation energy of fragmentation for several peptides in the gas phase. Singly charged bradykinin has an E_{act} of 125 kJ/mol, while the E_{act} of doubly charged bradykinin is 81 kJ/mol, with standard deviations of 3-10 kJ/mol. (See, Schnier, P. D.; Price, W. D.; Jockusch, R. A.; Williams, E. R. J. Am. Chem. Soc. 1996, 118, 7178, the disclosure of which is incorporated herein by reference.) If the conjugation of Vazo 68 to the peptide resulted in no change in the activation energy for fragmentation of the peptide, we would expect the doubly charged bradykinin conjugate to fragment into b- and y-type ions before the Vazo 68 moiety dissociated. However, this is contrary to the experimental evidence; therefore, the conjugation of the peptide to Vazo 68 changes the dissociation pathways and their activation energies. Accordingly, in one embodiment thermodynamic data can be combined with the results of BIRD experiments on the conjugated peptide species to obtain the E_{act} of dissociation and determine whether the activation energy of dissociating species, such as, for example, N₂ is lowered by peptide conjugation. It will be understood that such BIRD experiments may be used on several azo-conjugated peptides to provide a further framework for determining the reactivity and selectivity of the FRIPS process.

Finally, a combinatorial peptide library can also be used either alone or in combination with other data to determine the details of the FRIPS reaction mechanism and any potential enhancement of fragmentation at specific side chains. It is to be understood that certain amino acids, such as threonine and serine, can in some cases direct FRIPS cleavage processes. Moreover secondary structures can also have an effect on the process. Synthesis of peptides known to have specific secondary structures (such as (Ala)ₙ, which has an α-helical structure) have been examined to determine whether this influences FRIPS fragmentation, while synthesis of a sequence of polyglycine peptides containing one non-glycine residue have been examined to establish whether certain amino acids enhance specific backbone cleavages.

Selectivity Studies

In order to elucidate how the fragmentation pattern of a conjugated peptide can be varied with amino acid side chains, the FRIPS technique was used to examine a series of peptides, AARAAAXAA, where X=Y, S, T, F, I, L. It is shown that using FRIPS the conjugated peptides containing alcoholic and aromatic residues (serine, threonine, phenylalanine, tyrosine) tend to fragment preferentially around these residues. In addition, the conjugated peptides containing leucine and isoleucine (constitutional isomers) fragment differently from each other, such that a peptide containing leucine can be distinguished from one containing isoleucine using the FRIPS technique.

All peptides were obtained from Biomer Technology (Concord, Calif.) as crude (<70%). Crude peptides are sufficiently pure for this work, since subsequent isolation steps in the mass spectrometer select the species of interest. The crude peptides were diluted to 10 mg/mL in aqueous solution. A stock 60 mM aqueous solution of N-(3-Dimethylaminopropyl)-N′-ethylcarbodiimide hydrochloride (EDC) (Sigma-Aldrich) and a saturated aqueous solution of Vazo 68 (DuPont), shown in Schematic 1, above, were also prepared. A typical conjugation of the peptide and the free radical initiator was achieved by mixing 20 μL of the peptide solution with 10 μL of EDC solution and 10 μL of saturated Vazo 68 solution. This mixture was allowed to react for 1 hour at room temperature. Cleanup was accomplished using C18 ZipTips (Millipore) in the standard fashion. This product (in 5 μL of a 50:50 water-methanol 1% formic acid solution) was diluted to 250 μL with methanol and the solution was used for mass spectrometric studies with a LCQ Deca ion trap mass spectrometer.

Radicals are created in the mass spectrometer from Vazo 68 as depicted in Scheme 2, below. As shown, collisional activation of the conjugated peptide (1) yields two major products: a fragment corresponding to the loss of 28 Da (N₂), and another fragment corresponding to the loss of 154 Da. The latter ion is the free radical species generated by cleavage at the azo carbon (2).

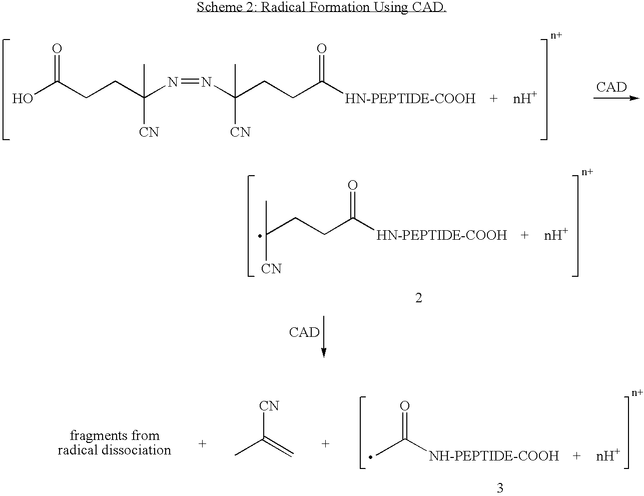

Subsequent dissociation of the radical species 2 results in the formation of another radical ion, 3, also shown in Scheme 2, formed by the loss of 2-methyl-acrylonitrile (67 Da). Also observed are a number of fragment ions, including a and z ions. Fragments with modifications corresponding to radical 3 are observed, as well as fragments with modifications corresponding to radical 2. The radical ion 3 can also be isolated and collisionally dissociated. Radical 3-type ions are referred to herein as “r(Peptide)”.

Fragments are assigned using the nomenclature of Biemann, with modifications for radical fragments. The literature on radical peptide fragments uses several different systems of nomenclature, so in the interests of clarity, the structures thought to correspond to the peptide fragments are shown in Scheme 3, below. Fragments that are modified by a radical as shown in 3 (C-terminal fragment ions of modified peptides) are denoted Maₙ, Maₙ•, etc.

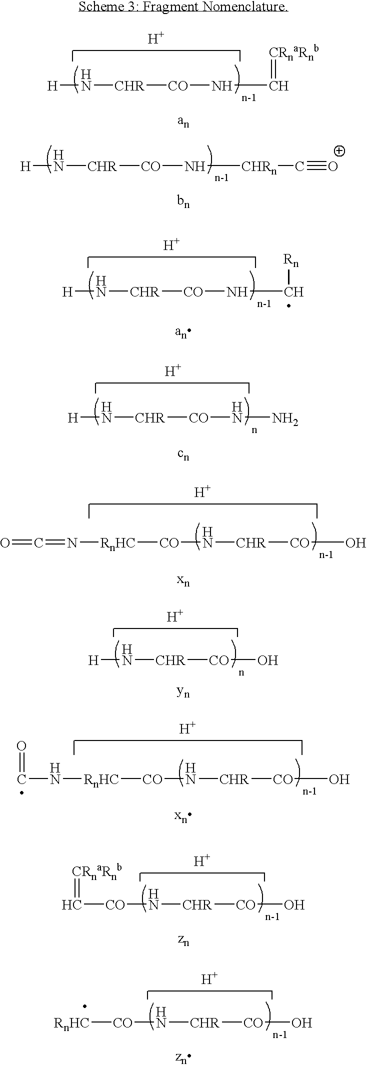

Comparison with Conventional CAD Technique

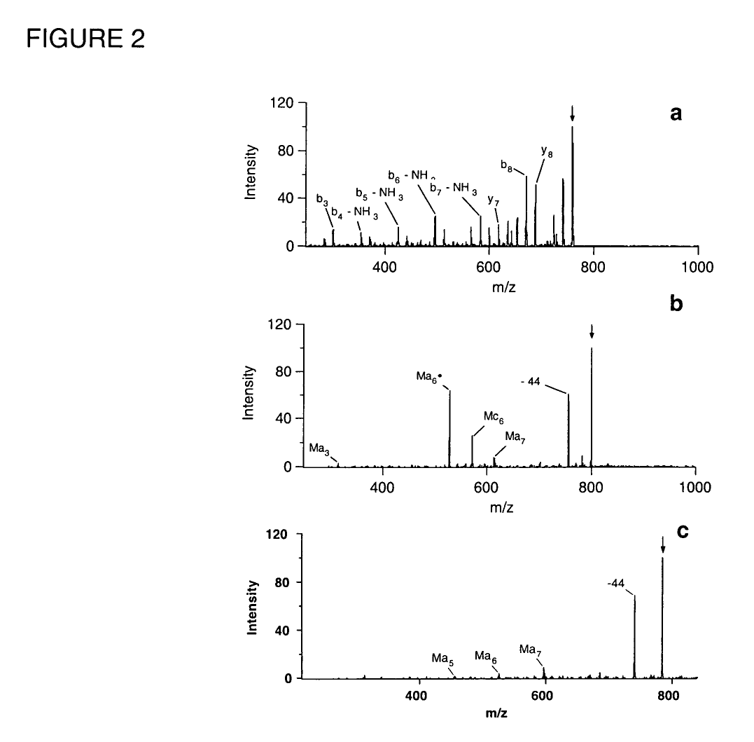

As discussed above, unlike traditional CAD, which is does not selectively fragment peptides and proteins, the FRIPS technique can be tuned, and is remarkably sensitive to changes in the nature of the bound peptide species. For example, FIG. 2a shows the results of collisionally activating the nonapeptide AARAAASAA. This spectrum is representative of the result of collisionally activating all such AARAAAXAA peptides that we have studied. The fragmentation is general, and b and y type fragments are observed. (Fewer y fragments are observed than b fragments because the charge carrier, arginine, is on the N-terminal side of the peptide.) Of note is the lack of selectivity in the fragmentation using the prior art CAD method.

In contrast, FIG. 2b shows the results of collisionally activating the radically modified peptide rAARAAASAA using the FRIPS method. The fragmentation pattern is significantly different from that shown in FIG. 2a. A loss of CO₂ (−44) is observed, as well as a large fragment corresponding to Ma₆• and smaller fragments corresponding to Mc₆, Ma₇, and (to a smaller extent) Ma₃. These fragments are shown schematically in Scheme 4. The majority of product fragments result from selective cleavage around the serine residue.

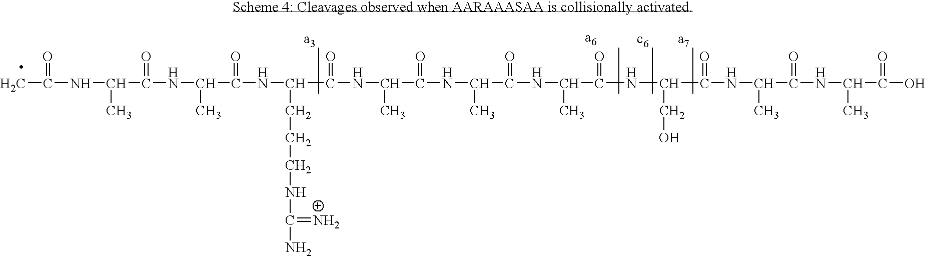

FIG. 2c shows the results of collisionally activating the radically modified peptide rAARAAAAAA. This peptide is used as a control in these experiments, as any cleavage-directing effects alanine has will be exhibited throughout the peptide. The dominant loss is CO₂. The fragments Ma₇, Ma₆, and Ma₅ are also observed in low yield.

Selectivity Based on Functional Group Identity

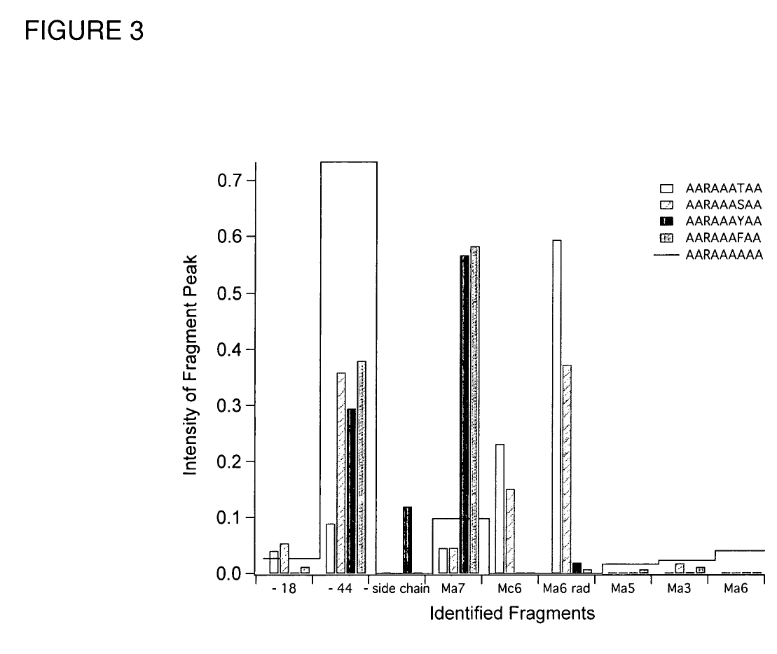

In another embodiment, it is shown that FRIPS can be used to determine the structure of a peptide based on the functional groups of the individual amino acids. For example, FIG. 3 shows the fragments obtained from collisional activation of radical peptides containing alcoholic or aromatic moieties. The intensity of the fragment peaks are expressed as a fraction of the sum of the intensities of all the fragments. The normalized results from peptides rAARAAATAA, rAARAAAYAA, rAARAAASAA, and rAARAAAFAA are shown as bars. rAARAAAAAA is shown as a line across the graph to facilitate comparison with the alcoholic and aromatic residue-containing peptides. While the Ma₇ peak is still the most prominent peak in the spectrum, Ma₆, Ma₅, and Ma₃ peaks are observed in higher proportions than for any of the other species listed. The peptides containing alcoholic residues also fragment differently from the aromatic residue containing peptides. If CO₂ loss is discounted, the peptides rAARAAATAA and rAARAAASAA (alcoholic residues) fragment primarily into Mc₆ and Ma₆• ions, while rAARAAAYAA and rAARAAAFAA (Sromatic residues) fragment primarily into Ma₇ ions, providing another example of how FRIPS can be used to selectively fragment species based on the identity of a functional group within the peptide.

Scheme 5 depicts a mechanism by which the a and c type fragments might form, using serine as a representative of this group of amino acids. Assuming abstraction of the side chain β hydrogen, β cleavage on the C-terminal side of the amino acid gives the aₙ₊1 fragment ion. Likewise, β cleavage on the N-terminal side of the amino acid results in cₙ fragments (with hydrogen transfer to the c fragment); β cleavage and additional loss of the stable molecule HNCO yields aₙΨ fragments.

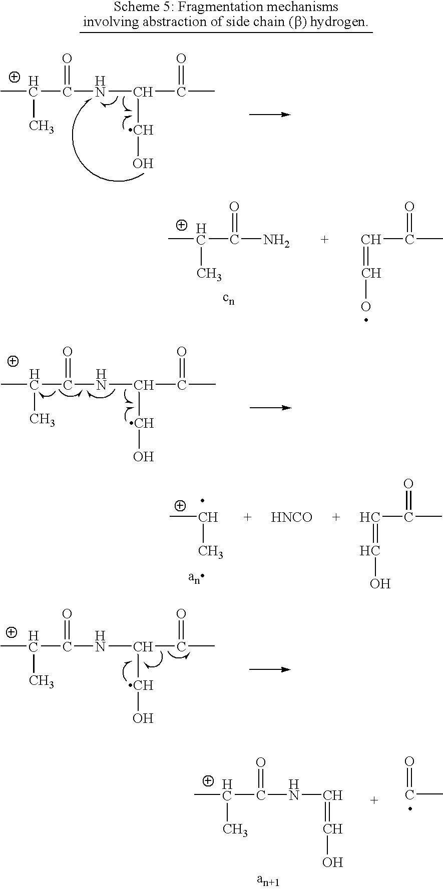

As discussed above, FIG. 3 provides evidence that the aromatic residues Y and F direct cleavage to the C-terminal side of the residue, while the alcoholic residues S and T direct cleavage to the N-terminal side of the residue.

Selectivity Based on Position of Residue

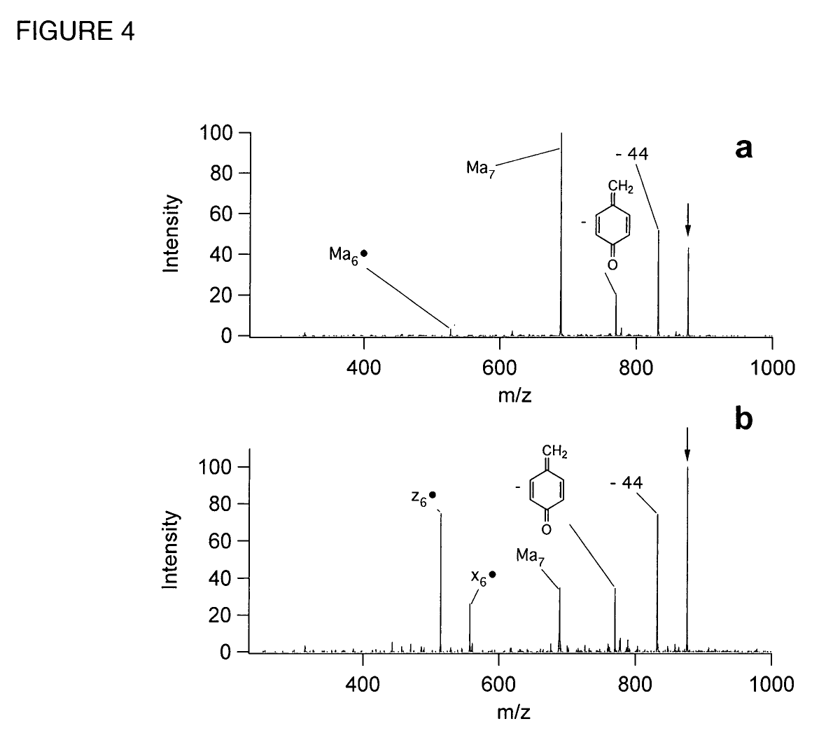

As discussed above, the peptide rAARAAAAAA shows more cleavage at the a₇ site than at other sites in the peptide. The sensitivity of the FRIPS technique to determine the position of the directing residue relative to the radical can also be shown by comparing the two peptides rAARAAAYAA and rAAYAAAARAA. Collisionally activating rAARAAAYAAA results predominantly in a fragment peak corresponding to cleavage at the tyrosine residue (Ma₇); the loss of the tyrosine side chain and a small amount of Ma₆• are also observed, as shown in FIG. 4a. (A small amount of Ma₃ fragment, corresponding to cleavage at the arginine residue, is also present.) When the positions of the tyrosine and the arginine are switched in the peptide, significantly more fragmentation is observed at the arginine, as shown by the prominence of the Ma₇ peak in FIG. 4b. However, the tyrosine side chain continues to strongly direct fragmentation. The most prominent fragment observed is the z₆•, which entails cleavage adjacent to the tyrosine. Also prominently seen are the x₆• fragment and a fragment corresponding to the loss of the tyrosine side chain.

The results of fragmenting the rAAYAAARAA peptide are also most readily explained by positing abstraction of a side chain (β) hydrogen, followed by β cleavage, as shown in Scheme 6. The side chain loss of the tyrosine moiety can occur when the alcoholic hydrogen is abstracted and subsequent loss of the resonance-stabilized para-quinone methide group occurs.

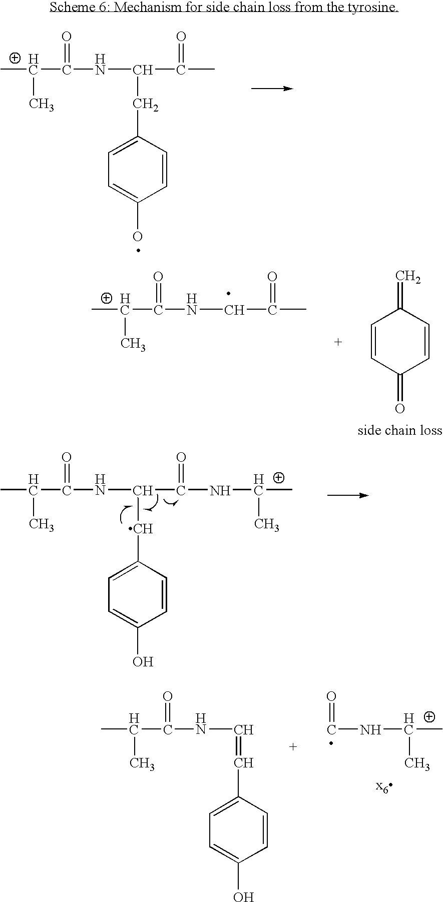

FRIPS Detection of Isomers

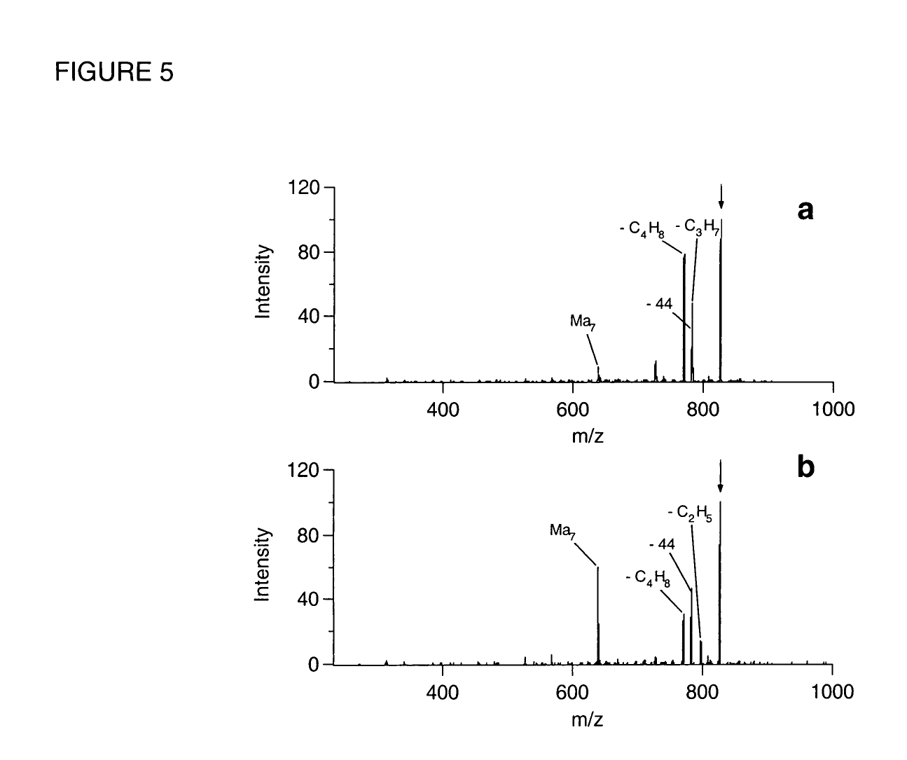

In many cases, fragmentation of rAARAAAXAA leads to side chain losses. FIG. 5 shows the results of collisional activation of the two peptides rAARAAAIAA and rAARAAALAA. Leucine and isoleucine are isomers and difficult to distinguish when using conventional mass spectrometric sequencing techniques. However, there are several methods that discriminate between leucine and isoleucine. (See, e.g., Meot-Ner, M. J. Am. Chem. Soc. 1983, 105, 4912; Julian, R. R.; Beauchamp, J. L. Int. J. Mass Spectrom. 2001, 210, 613; and Julian, R. R.; Beauchamp, J. L. Int. J. Mass Spectrom. 2001, 210, 613, the disclosures of which are incorporated herein by reference.) Gatlin et al. used copper (II) complexed with amino acids to distinguish between these two isomers. They found that collisional activation of such complexes with leucine and isoleucine amino acids resulted in distinctive losses of C₃H₇ and C₂H₅, respectively.

In FIG. 5, we see that the radical peptides rAARAAALAA and rAARAAAIAA exhibit losses of C₃H₇ and C₂H₅, respectively, upon collisional activation, in analogy to the results found for the copper (II) complexes. However, these are not the predominant fragment peaks in either FRIPS spectra. For rAARAAALAA, the predominant fragment peak is due to a loss of C₄H₈; rAARAAAIAA's predominant breakup leads to the formation of a Ma₇ ion.

These results can be understood with reference to Scheme 7. If the hydrogen abstracted by the radical portion of rAARAAALAA is the α (backbone) hydrogen of the leucine, the reaction can proceed via β cleavage to lose C₃H₇. Likewise, in the case of isoleucine, α hydrogen abstraction followed by β cleavage results in the loss of C₂H₅. However, if instead a hydrogen is abstracted from the side chain of the amino acid, different fragments result. To form a tertiary radical, abstraction must occur at the γ hydrogen in leucine, or the β hydrogen in isoleucine, as shown in Scheme 7. Then β fragmentation results in the loss of C₄H₈ (for leucine) or the formation of the Ma₇ fragment (for isoleucine). These constitute the major fragment ions in both spectra shown in FIG. 5. These results indicate that while both backbone and side chain hydrogens are abstracted from the leucine or isoleucine residues, side chain abstraction is the preferred pathway, and in turn that using FRIPS even isomers can be distinguished.

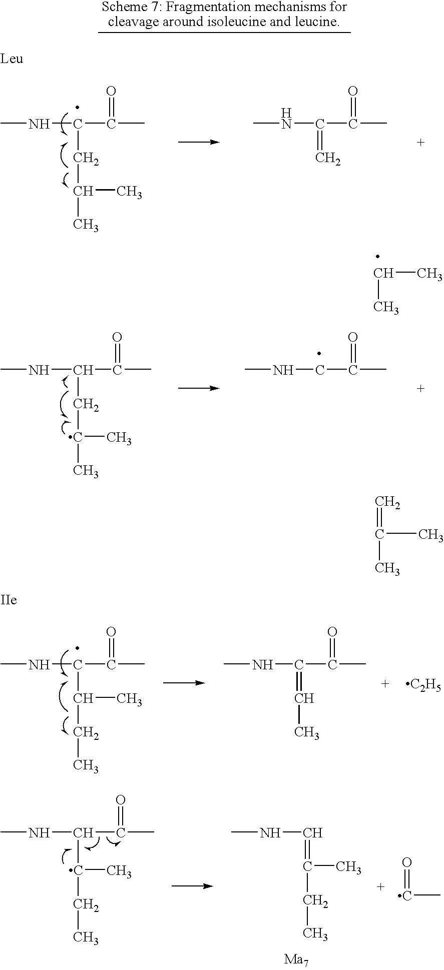

The above demonstrates that the FRIPS technique can provide site-selective cleavage of peptides through collisional activation of free radical initiator-peptide conjugates. This in turn allows for a gas-phase approach to protein sequencing, where radicals are used to selectively cleave a protein in analogy to a tryptic digest. Although only results from the use of Vazo 68 are discussed above, using the thermodynamic, structural, and dynamic information provided herein, one of ordinary skill in the art will understand that other, similar free radicals can be devised that cleave a protein indiscriminately, that bind non-covalently to specific residues in a protein, or that fragment more cleanly than Vazo 68. In addition, by controlling the pH of the solution phase reaction, solvent-accessible lysine residues can be modified in addition to the N-terminus, providing multiple radical initiation sites.

### EXAMPLE 1

### Covalently Bound Radicals

In one exemplary embodiment, the water-soluble free radical initiator Vazo 68, shown in Scheme 1, is conjugated to the N-terminus of a peptide. The conjugate is electrosprayed into an ion trap mass spectrometer, where CID results in free radical formation at the azo moiety.

In the current example, Vazo 68 was procured from DuPont (www.dupont.com). To synthesize conjugated peptides, Vazo 68 and N,N-dicyclohexylcarbodiimide (DCC) were dissolved in N,N-dimethylformamide (DMF) at concentrations of approximately 40 mM. This solution was added to an equivalent volume of 2-5 mg/mL aqueous solution of peptide and the reaction mixture was protected from light. All peptides were obtained from American Peptide Company (Sunnyvale, Calif.). The reaction was allowed to progress for one hour. This solution was then diluted by 10⁵ in methanol and used in electrospray experiments. Vazo 68 was in turn transformed to the dichloride species and added to 18-crown-6-methanol to generate the molecule in Scheme 8, below.

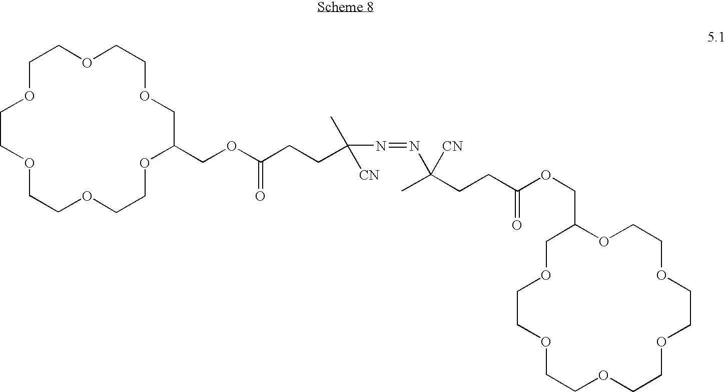

All experiments were conducted on an LCQ Deca quadrupole ion trap instrument with a standard electrospray ion source. Solution flow rates were 3 μL/min. Ions of interest were isolated and subjected to collisional activation with helium gas until product peaks were observed.

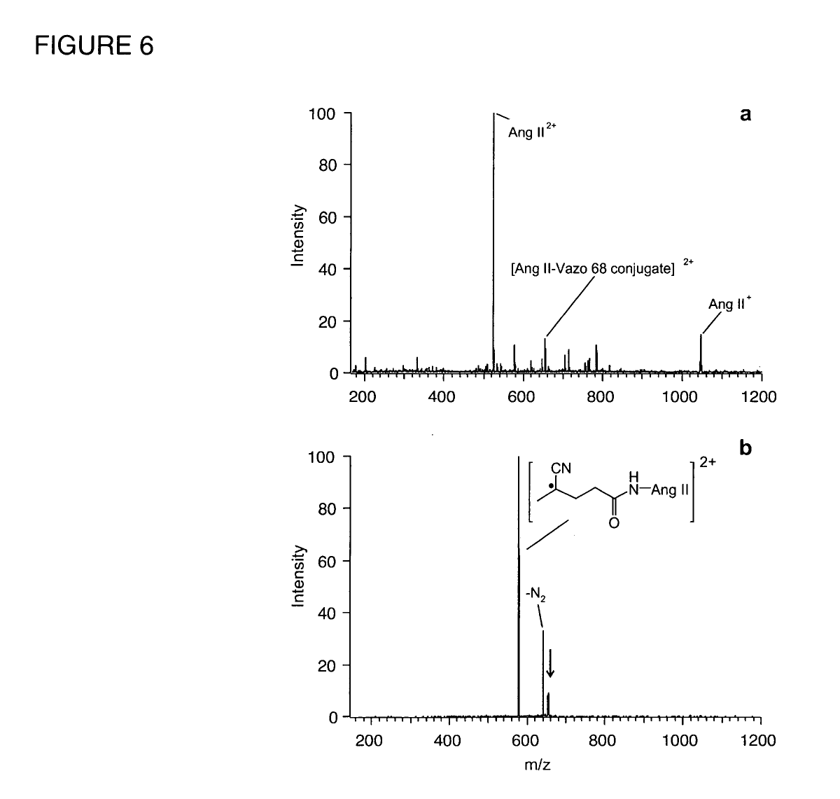

A mass spectrum of a solution of a derivatized peptide, Angiotensin II, is shown in FIG. 6a. In this case, the derivatized, doubly charged peptide is present at an intensity 12% that of the most abundant ion intensity. In general, the Vazo 68 derivatized peptides (shown generally as 5.2 in Scheme 9 below) were detected at intensities ranging from 1% to 15% of the most abundant ion intensity. Typically the most abundant ion was the underivatized peptide.

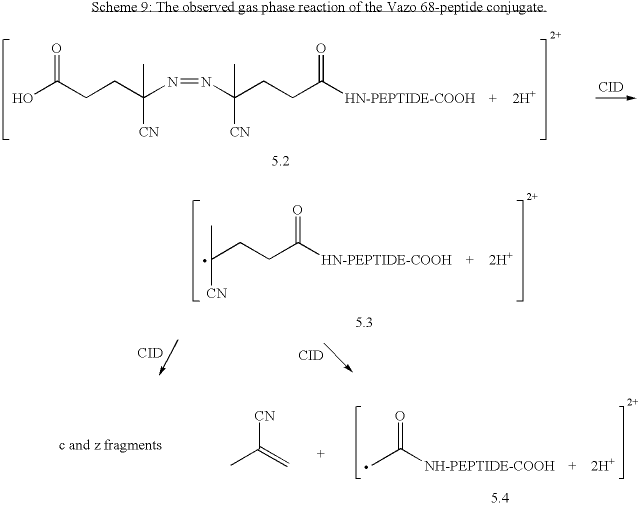

FIG. 6b shows the results of CID of the Vazo 68 derivatized peptide. The major peak in the spectrum corresponds to formation of a free radical species obtained from decomposition of the azo moiety, shown generally as 5.3 in Scheme 9. A loss of 28 Daltons is also observed, which corresponds to loss of N₂. Symmetrical azoalkanes like Vazo 68 tend to decompose by simultaneous loss of N₂ and generation of two alkyl radicals. (See, Nauser cited above.) MS³ experiments on the N₂ loss peak show b- and y-type fragment ions, as well as losses of 27 and 126, corresponding to HCN and the tertiary radical of 4-cyano-4-methylbutyric acid, respectively. The 4-cyano-4-methylbutyric acid radical corresponds to half of the Vazo 68 species after N₂ is lost and appears to form a non-covalent adduct with the peptide following initial dissociation of the azo moiety. The fragmentation pattern shown in FIG. 6b is observed for all Vazo derivatized peptides studied and is considered to be diagnostic of the presence of the Vazo derivatized peptide.

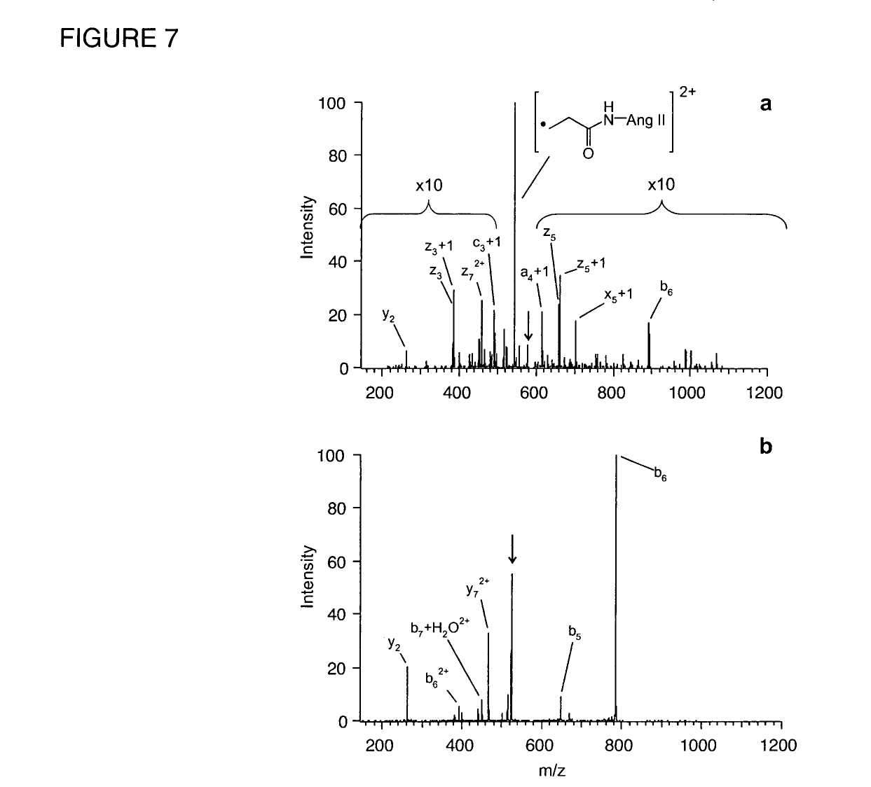

The newly formed free radical species, generally referred to as 5.3, can be subjected to further collisions. FIG. 7a shows the results of isolation of 5.3 in the case of angiotensin II, DRVYIHPF. The major product ion results from the fragmentation of the remaining covalently bound Vazo 68 to give a primary free radical 5.4 (Scheme 9) and 2-methyl acrylonitrile. Again, this product is commonly observed with high abundance for the peptides studied. Also produced are a number of fragment ions, including the z₃, z₅, z₇, c₃, x₅, and a₄ fragments. FIG. 7b shows the spectrum resulting from collision-induced dissociation of unmodified angiotensin II. In comparing these two spectra, we see that the unmodified peptide yields predominantly b- and y-type fragment ions under CID, while the free radical peptide 5.3 yields predominantly x and z fragments, and the fragmentation occurs at different sites on the peptide backbone. The x and z fragments are also commonly observed in electron capture dissociation experiments, in which peptides are made into radical species by the pickup of an electron. Scheme 10, below contrasts the location of the backbone cleavages for CID fragmentation and FRIPS fragmentation. In the ECD spectrum of a similar peptide, angiotensin I (DRVYIHPFHL), fragments are observed that arise from many more peptide backbone cleavages (z₁, z₂, z₅, c₁, c₂, c₃, c₅, c₆, c₇, c₈). (Tsybin, Y. O.; Hakansson, P.; Weterhall, M.; Markides, K. E.; Bergquist, J. Eur. J. Mass Spectrom. 2002, 8, 389, the disclosure of which is incorporated herein by reference.) FRIPS results in fewer fragments and is a more selective fragmentation process.

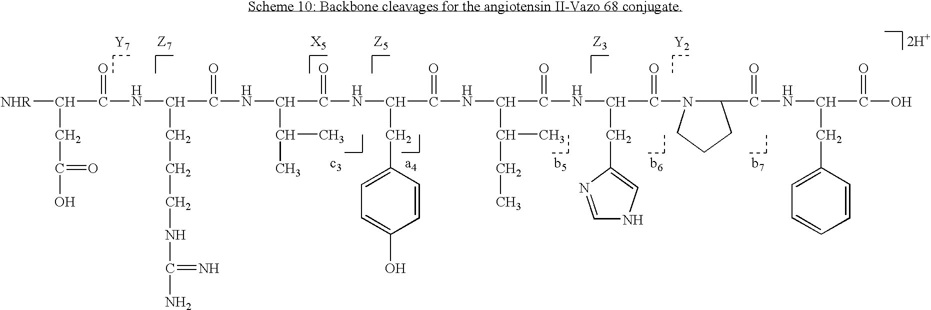

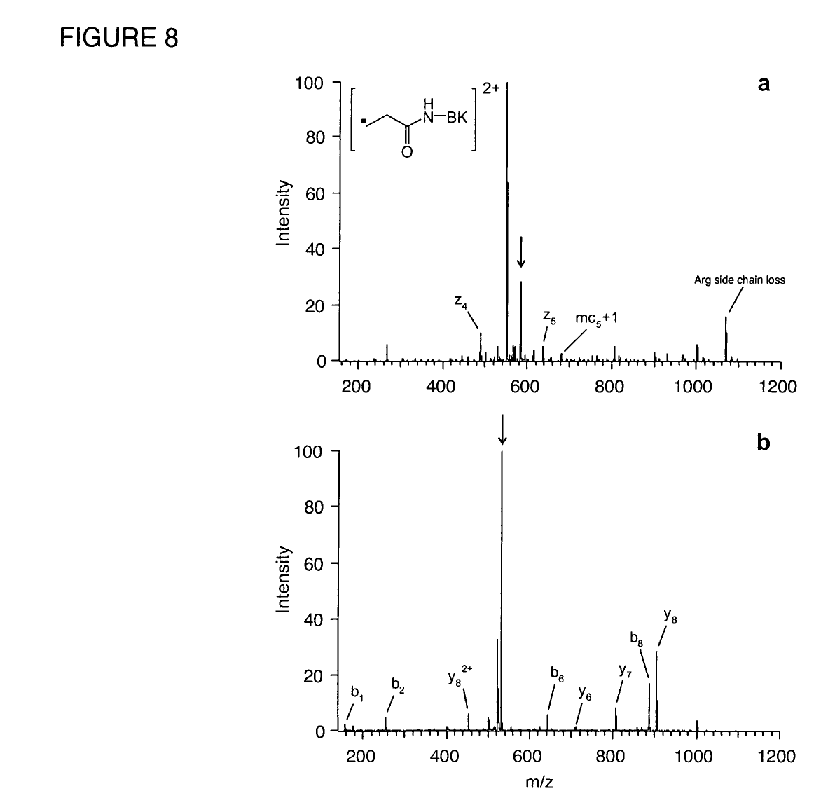

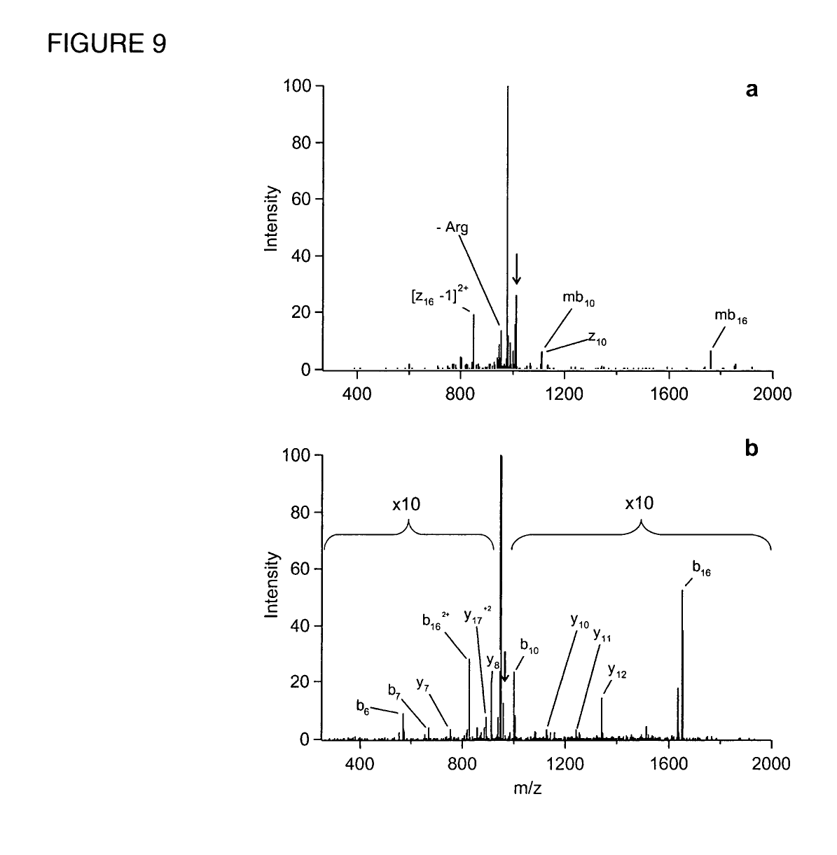

FIGS. 8 and 9 show results of collision-induced dissociation of both derivatized and unmodified free bradykinin, RPPGFSPFR, and anxiety peptide, QATVGDVNTDRPGLLDLK. In both cases, the free radical induced peptide sequencing (FRIPS) technique results in fewer identifiable backbone fragments than collision-induced dissociation of the unmodified peptide. Table 2 summarizes the results of the collision-induced dissociation experiments conducted on protonated, larger peptides. The peptides KA, RL, and GGH were also examined, but typically the MS³ step resulted only in loss of 2-methylacrylonitrile and did not produce fragments resulting from peptide backbone cleavage. In addition, the large protein ubiquitin, with 77 amino acids, was also studied. While multiple CID steps were diagnostic of free radical formation, and FRIPS spectra showed differences from conventional CID spectra, the spectra were too complex to be readily interpreted.

TABLE 2
Results of FRIPS experiments

| Peptide | Sequence | CID Fragments | FRIPS Fragments* |
|---|---|---|---|
| Angiotensis II²⁺ | DRVYIHPF | b₇, y₇, b₅, b₆, y₂ | z₇, x₅, z₅, z₃, y₂, b₆ |
| Bradykinin²⁺ | RPPGFSPFR | b₁, y₈, b₂, y₇, b₆, b₈ | z₅, c₅, c₄ |
| Anxiety | QATVGDVNT | b₆, b₇, y₇, b₁₆, y₁₇, y₈, | z₁₆, z₁₀, b₁₀, b₁₆, |
| Peptide²⁺ | DRPGLLDLK | b₁₀, y₁₀, y₁₁, y₁₂ | |
| ACTH⁺⁴ | SYSMEHFRW | b₂, b₈, y₂₂, b₁₁, y₁₃, | z₂₂, z₁₇ |
| | GKPVGKKRR | y₁₉, y₂₀, y₂₁, y₁₆ | |
| | PVKVYP | | |
| Met-Enk⁻¹ | YGGFM | c₂, Y₂, x₃ + 1, b₄ | z₄, x₄, -Tyr, -Met |

*Fragments are from MS3 spectra, where conjugated peptide is isolated and then activated (MS2) and then dissociated (MS3).

Excluding angiotensin II, the peptides listed in Table 2 all undergo more fragmentation when subjected to CID than when the conjugated peptide is subjected to FRIPS. This is especially noticeable for larger peptides. For example, the anxiety peptide is 18 residues long. It cleaves at seven distinct sites in CID experiments, but only at four distinct sites in FRIPS experiments (Scheme 11, below). The z fragments occur at the C-terminal side of a threonine residue, which has a hydroxyl group. It is likely that the observed b fragments result from CID-type excitation, as the b₁₀ and b₁₆ fragments are formed with relatively high yield when the underivatized peptide is dissociated, as shown in FIG. 9. 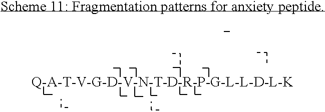
Fragmentation of the peptide is initiated by abstraction of a hydrogen atom from the peptide by the Vazo 68 radical, followed by β-cleavage. More weakly bound hydrogen atoms should be abstracted preferentially, resulting in selective fragmentation. Calculations of the bond dissociation energies (BDEs) of bonds along the peptide backbone suggest that the α-carbon hydrogens are most weakly bound, with BDEs ranging from 326-369±10 kJ/mol depending on the side chain. (See, Rauk, A.; Yu, D.; Taylor, J.; Shustov, G. V.; Block, D. A.; Armstrong, D. A. Biochemistry 1999, 38, 9089, the disclosure of which is incorporated herein by reference.) Secondary structure increases the BDEs, by about 10 kJ/mol for a β-sheet and 40 kJ/mol for an α-helix, and may play an important role in determining the selectivity of radical induced fragmentation. In comparison, a model for the radical derived from Vazo 68, 2,2′-azobis(2-methylpropionitrile) (AIBN), has a C—H bond energy at the 3° carbon of 362±8 kJ/mol. However, the abstraction of an α-carbon hydrogen cannot explain the majority of fragments seen using FRIPS, as β-cleavage would generate b- and y-type fragment ions.

Hydrogen atom abstraction may also occur from amino acid side chains. Abstraction of hydrogen from a methylene attached to the α-carbon, followed by β-cleavage along the backbone, could produce either c and z or a and x fragments, as shown in Scheme. These types of fragments are the majority of fragments observed in the FRIPS fragmentation process. The α-carbon hydrogen in ethanol, a model for the serine side chain, has a BDE of 389±8 kJ/mol, and the α-carbon hydrogen in t-butanol, a model for the threonine side chain, has a BDE of 381±4 kJ/mol. Abstraction by the Vazo 68 radical of either of these hydrogens would be only slightly endothermic. For reference, the BDE of ethane (an alanine model) is 423±2 kJ/mol.

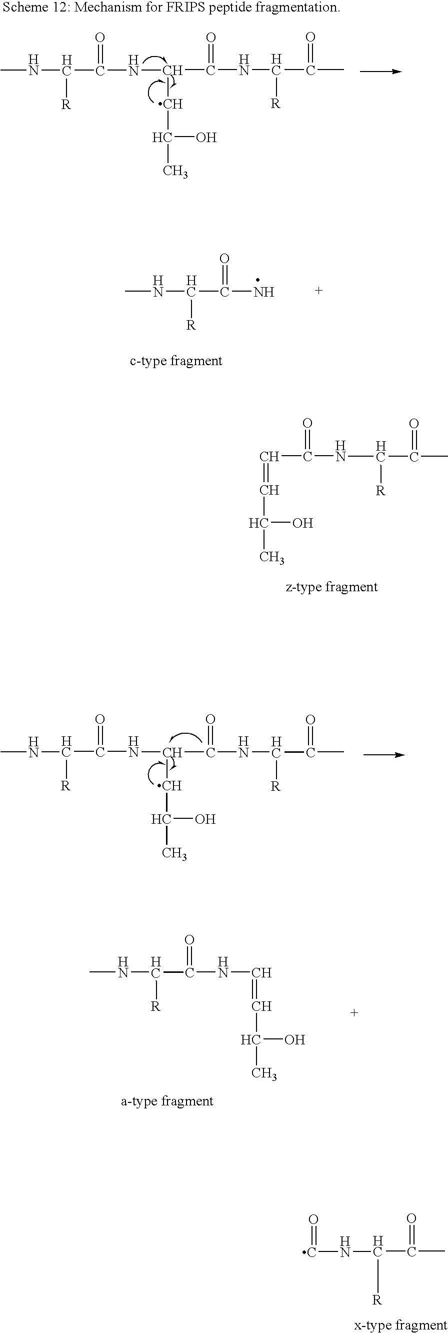

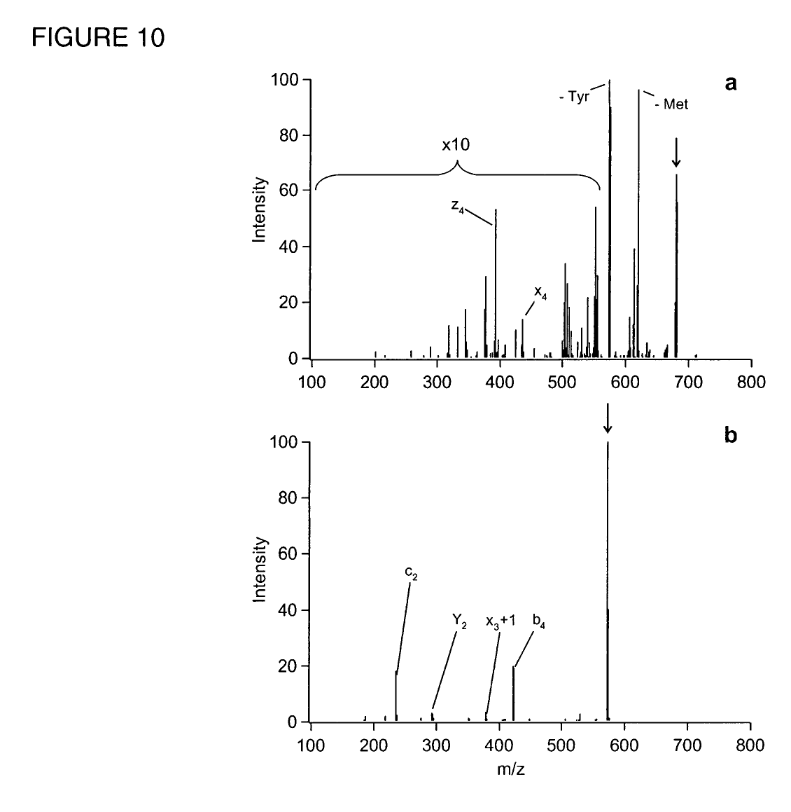

As previously discussed, the FRIPS technique works in negative ion mode as well as positive ion mode, as shown in FIG. 10a. The loss of the methionine side chain and tyrosine side chain dominate the spectrum. The O—H BDE of the tyrosine side chain may be approximated by that of phenol, 361.9±8 kJ/mol, making the abstraction of phenolic hydrogen thermoneutral. This species could then react to lose an OC₆H₄CH₂ quinolic molecule, resulting in the peak labeled “-Tyr” in FIG. 10. A similar side chain abstraction may result in the loss of the methionine side chain.

### EXAMPLE 2

### Noncovalently Bound Radicals

The crown ether 18-crown-6 (18c6) complexes readily with ammonium ions in the gas phase. (See, Maleknia, S.; Brodbelt, J. J. Am. Chem. Soc. 1993, 115, 2837, the disclosure of which is incorporated herein by reference.) This molecule has been previously used for molecular recognition of lysine in small peptides and proteins. The compound in Scheme 8 was synthesized to combine the molecular recognition properties of 18c6 with the radical initiator Vazo 68. The compound should preferentially bind to lysines, and the radical generated from this species, Scheme 13, could then cleave a peptide at sites adjacent to a lysine residue.

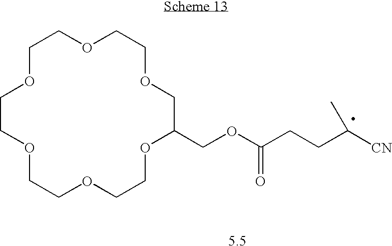

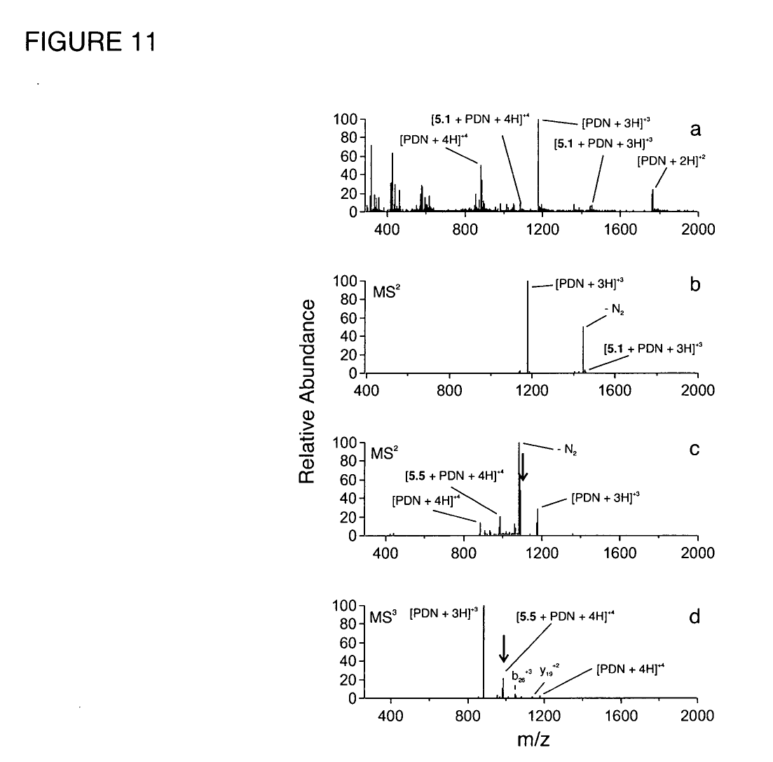

FIG. 11 shows the results of an experiment using 5.1 and the peptide prodynorphin (PDN), with the sequence YGGFLRRQFKVVTRSQEDPNAYYEELFDV. This peptide has three arginine (R) residues and one lysine (K) residue. The full mass spectrum shown in FIG. 11a shows formation of adduct peaks. When the +3 adduct is dissociated, the predominant reaction pathway leads to loss of 5.1, and loss of N₂ is also observed, as shown in FIG. 11b. The N₂ loss product dissociates to give +3 PDN (data not shown). Since there are three arginines and three protons, the arginines may be sequestering the charge from the lysine residue. In this case, the crown ether would associate with arginine, which binds 18c6 less strongly than lysine does.²⁴

The spectrum obtained from collisionally activating the +4 adduct is shown in FIG. 11c. An activated radical, [5.5+PDN+4H]⁴⁺, is produced, along with a loss of N₂ and loss of 5.1. In this case, there are enough protons to protonate all three arginine residues and the lysine residue. Subsequent dissociation of the activated radical [5.5+PDN+4H]⁴⁺ predominantly results in loss of the radical species, which abstracts a proton to give [PDN+3H]³⁺ or is lost as a neutral so that [PDN+4H]⁴⁺ is seen. However, some fragmentation products are also observed. The fragment tentatively assigned as y₁₉²⁺ in FIG. 11d corresponds to a fragmentation on the C-terminal side of the lysine residue, as would be expected if the crown ether were noncovalently bound to lysine. However, the b₂₆³⁺ fragmentation site is far from the lysine residue. A different 18c6-radical initiator, that produces a less stable radical, might result in more backbone fragmentation and provide more insight into whether selective fragmentations can be achieved by combining non-covalent complexation of an 18c6 with a radical species.

### EXAMPLE 3

### PTMs

In many proteomics studies, the identification of post-translational modifications (PTMs) to proteins is critical to identifying regulatory pathways. (See, e.g., Mann, M.; Ong, S. E.; Gronborg, M.; Steen, H.; Jensen, O. N.; Pandey, A. “Analysis of protein phosphorylation using mass spectrometry: deciphering the phosphoproteome,” Trends in Biotechnology. 2002, 20, 261-268, the disclosure of which is incorporated herein by reference.) In particular, phosphorylation plays a major role in transmembrane signal transduction, and approximately one-third of eukaryotic proteins are phosphorylated at any given time. Hunter, T. Signaling—2000 and beyond. Cell. 2000, 100, 113-127; Zolnierowicz, S.; Bollen, M. “Protein phosphorylation and protein phosphatases,” The EMBO Journal. 2000, 19, 483-488, the disclosures of which are incorporated herein by reference.) Abnormal phosphorylation is often a cause or result of a disease state. (See, e.g., Cohen, P. “Protein kinases—the major drug targets of the twenty-first century?,” Nature Reviews Drug Discovery. 2002, 1, 309-315, the disclosure of which is incorporated herein by reference.) In this exemplary embodiment it is shown that FRIPS retains phosphorylation sites in peptides. Data for Angiotensin II phosphorylated on the tyrosine residue is presented and compared with CAD results on the same peptide. While CAD results in a prominent peak corresponding to the loss of HPO₃ and H₂O, FRIPS results in very little of this product.

Phosphorylated Angiotensin II, DRV[pY]IHPF (Nova Biochem) was dissolved in water to a concentration of 10 mg/mL. A stock 60 mM aqueous solution of N-(3-Dimethylaminopropyl)-N′-ethylcarbodiimide hydrochloride, EDC (Sigma-Aldrich) and a saturated aqueous solution of Vazo 68 (DuPont), shown in Scheme 1, were also prepared. Conjugation of the peptide and the free radical initiator was achieved by mixing 20 μL of the peptide solution with 10 μL of EDC solution and 10 μL of saturated Vazo 68 solution. This mixture was allowed to react for 1 hour at room temperature. Cleanup was accomplished using C18 ZipTips (Millipore) using the standard procedure. The clean product (in 5 μL of a 50:50 water-methanol 1% formic acid solution) was diluted to 250 μL with methanol and this solution was used for mass spectrometric studies with a LCQ Deca ion trap mass spectrometer.

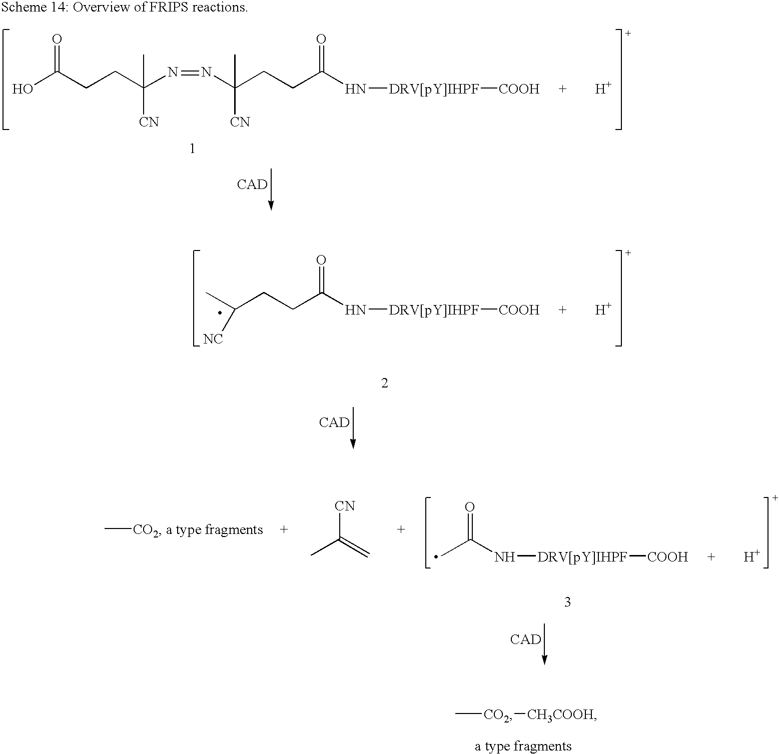

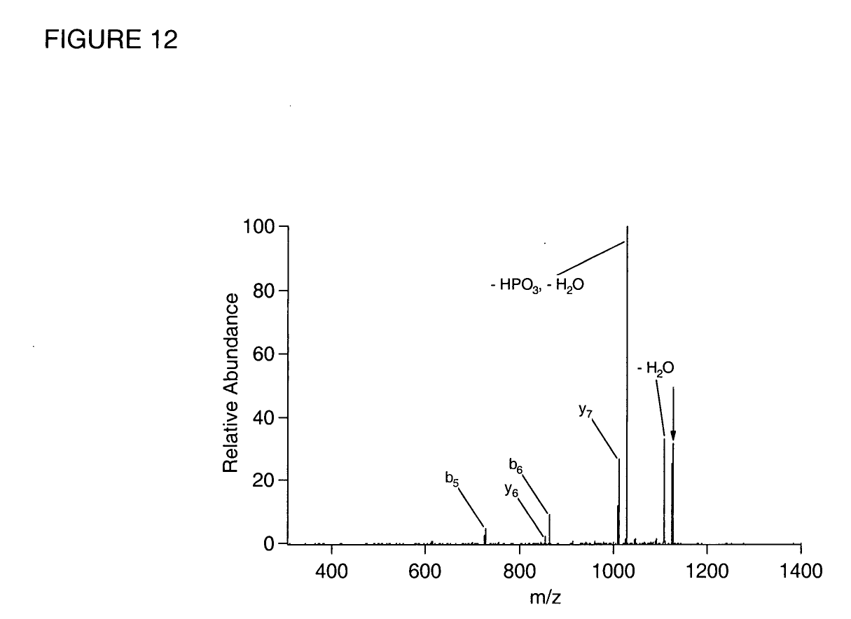

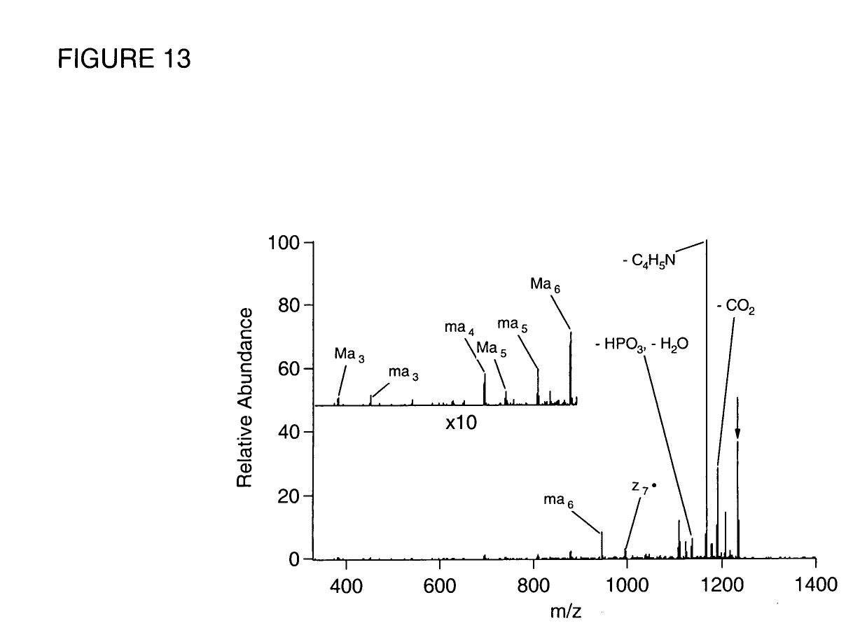

FIG. 12 shows the CAD spectrum of singly protonated DRV[pY]IHPF. The most prominent peak in the spectrum corresponds to a loss of 98 Da, which we assign as the loss of HPO₃ and H₂O. Also seen is a series of b-type fragment ions at lower intensities. (The b₃, b₄, and y₅ peaks are also seen at very low intensity, and are unlabeled in the figure.) FIG. 13 shows the analogous FRIPS spectrum, where the species labeled as 2 in Scheme 14 is collisionally activated. The predominant peak in this spectrum corresponds to a loss of 67 Da, assigned as 2-methyl-acrylonitrile. Small molecule losses of 44 Da and 60 Da are seen, as well as some a-type fragments characteristic of the FRIPS process. The small molecule losses can be assigned to CO₂ and CH₃COOH, respectively.

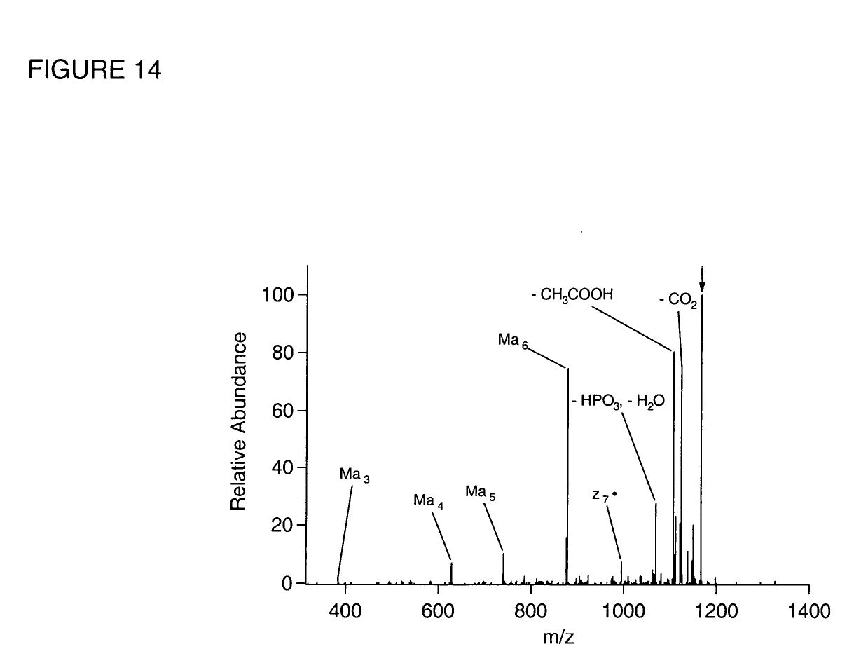

FIG. 14 shows another FRIPS spectrum, where the species labeled as 3 in Scheme 14 is collisionally activated. This species was examined because, unlike species 2, it cannot undergo facile β cleavage at the site of radical formation. Because of this, there should be a higher proportion of sequencing information in the spectrum. As is seen a strong signal from the a₆ ion is observed. The 98 Da loss is present, but is much smaller than the analogous loss observed in FIG. 12. Small molecules are lost as for the case of FIG. 13, and sequence information is provided by the a-type ion series.

Accordingly, FRIPS can also be used to study proteins with significant post-translational modifications. A radical suitably tuned to maximize either selectivity or fragmentation could be used in a completely gas-phase approach to protein sequencing and could also be used to identify sites of post-translational modification in proteins.

### EXAMPLE 4

### Protein Analysis

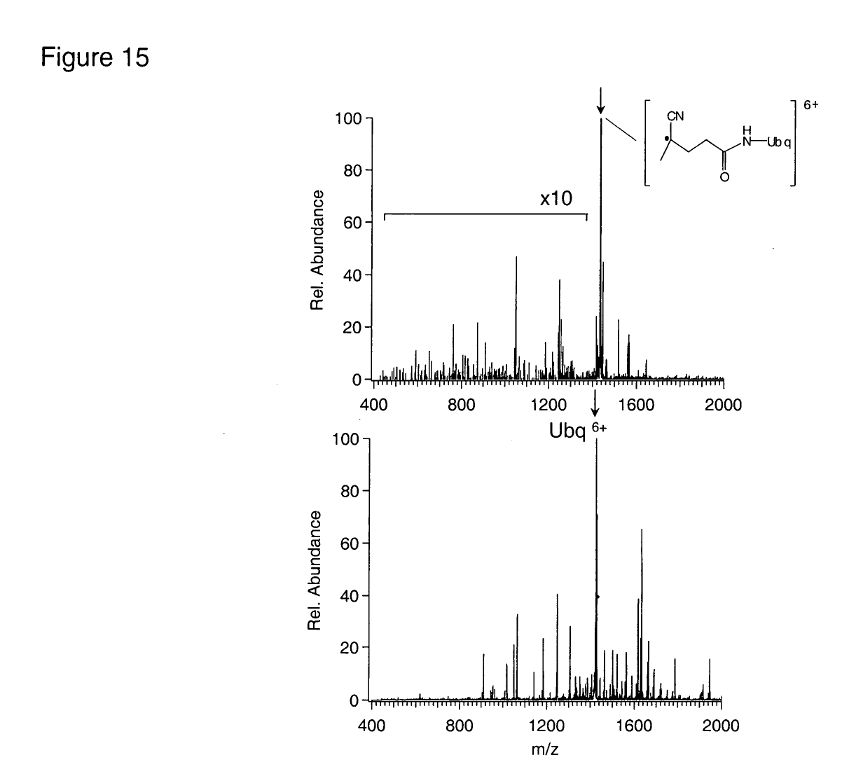

FIG. 15 shows a FRIPS spectrum from the protein ubiquitin. Although the mass resolution of the LCQ ion trap used in the current experiments was not sufficient to allow us to unambiguously assign peaks, the data presented in FIG. 15 does provide evidence that the FRIPS process can be used to analyze proteins as well.

Although specific methods and radical initiators are described above, it should be understood that by tuning the free radical initiator to the selectivity desired for the specific molecule, FRIPS can be used as a true gas phase enzyme, cleaving only at specific side chains in a protein, and allowing for a completely gas phase approach to peptide sequencing. In addition, FRIPS can also be used to study biologically relevant reactions of free radicals with peptides and proteins in the gas phase, removing the complications of environmental effects.

Moreover, although only collisional dissociation of the free radical conjugates is discussed above, it should be understood that any suitable technique for activating the free radical initiators and for further fragmenting the radicals formed by those activated conjugates may be used. It further holds that any suitable method of analyzing the fragments produced from the FRIPS process may be used, such as, for example mass spectrometry.

Finally, although the foregoing refers to particular preferred embodiments, it will be understood that the present invention is not so limited. It will occur to those of ordinary skill in the art that various modifications may be made to the disclosed embodiments and that such modifications are intended to be within the scope of the present invention.

What is claimed is:

1. A method of selectively fragmenting and analyzing molecules comprising:
providing a free radical initiator and a target molecule;
conjugating the free radical initiator to the target molecule;
collisionally activating the conjugate to form a plurality of molecular fragments wherein the molecular fragments include at least one free radical species;
further collisionally dissociating the molecular fragments to form ion fragments, wherein the selectivity of the fragmentation is on based on the interaction of the free radical initiator and the target molecule; and
analyzing the ion fragments.

2. The method of claim 1, wherein the free radical initiator is selected from the group consisting of peroxides, nitrites, alkoxyamines, and disulfides.

3. The method of claim 1, wherein the free radical initiator has an azo moiety

4. The method of claim 3, wherein the target molecule is a peptide and the free radical initiator is conjugated to the N-terminus of the peptide.

5. The method of claim 4, wherein the step of collisional activation includes breaking a bond at the azo moiety of the free radical initiator.

6. The method of claim 1, wherein the collisional activation includes introducing the conjugate into a mass spectrometer.

7. The method of claim 1, wherein the ions are analyzed using mass spectrometry.

8. The method of claim 1, wherein the free radical initiator is Vazo 68.

9. The method of claim 1, wherein the target molecule is a protein.

10. The method of claim 1, wherein the method is performed in the gas phase.

11. The method of claim 1, wherein the ions obtained are selected from the group consisting of a, b, c, x, y, and z-type fragments.

12. The method of claim 1, wherein the ions result from amino acid side chain fragmentation.

13. The method of claim 1, wherein the ions are analyzed to determine the secondary structure of the target molecule.

14. The method of claim 1, wherein the ions formed are one of either anions and cations.

15. The method of claim 1, wherein the fragments formed are one of either singly or multiply charged.

16. The method of claim 1, wherein the fragments formed retain any PTMs in the original target molecule.

17. The method of claim 1, wherein the ions are analyzed to determine distinguish isomers.

18. The method of claim 1, wherein the fragments are generated photochemically.

19. The method of claim 1, wherein the free radical initiator is covalently bound to the target molecule.

20. The method of claim 1, wherein the free radical initiator is non-covalently bound to the target molecule.

21. An apparatus for selectively fragmenting and analyzing molecules comprising:
a source of conjugated free radical initiators and target molecules, wherein the free radical initiators have an azo moiety;
a collision activation chamber in fluid communication with said source, said chamber being designed to collisionally activate the conjugates to form a plurality of free radicals, and to further collisionally dissociate the free radicals into a plurality of radical fragments, wherein the selectivity of the fragmentation is on based on the interaction of the free radical initiator and the target molecule; and
a detector in fluid communication with said chamber for analyzing the radical fragments.
